(19) United States
(12) Patent Application Publication
(10) Pub. No.: US 2012/0154908 A1
(43) Pub. Date: Jun. 21, 2012

(54) REFLECTION TYPE SCREEN AND METHOD OF MANUFACTURING REFLECTION TYPE SCREEN

(75) Inventor: Masashi Kitabayashi, Azumino-shi (JP)

(73) Assignee: SEIKO EPSON CORPORATION, Tokyo (JP)

(21) Appl. No.: 13/326,236

(22) Filed: Dec. 14, 2011

(30) Foreign Application Priority Data
Dec. 15, 2010 (JP) 2010-278925

(51) Int. Cl. G03B 21/56; B29C 41/20

(52) U.S. Cl. 359/449; 156/245

(57) ABSTRACT

The invention relates to a reflection type screen capable of reducing contact resistance between a reflection surface and a rear surface of a screen base, and to a method of manufacturing this reflection type screen. A reflection type screen includes a sheet-shaped base (screen base) which is flexible and has a first surface (base front surface) reflecting projection light and a second surface (base rear surface) as the surface opposite to the first surface (base front surface). The second surface (base rear surface) has an uneven shape (uneven surface). The uneven shape (uneven surface) is uniformly formed. The uneven shape (uneven surface) has crimps.

### BACKGROUND

1. Technical Field

The present invention relates to a reflection type screen and a method of manufacturing a reflection type screen.

2. Related Art

A reflection type screen is known as a screen which reflects projection light outputted from a projection type display apparatus such as a projector and displays an image. One type of this screen is formed on a sheet-shaped synthetic resin base, and has a plurality of hemispherical patterns on a projection light reflection surface (reflection surface). The surface (rear surface) on the side opposite to the projection light reflection surface (surface on the opposite side) is generally an untreated surface on which a flat base surface is exposed.

For example, JP-A-2009-15196 discloses a method of manufacturing a reflection type screen, which method deposits material such as aluminum in an oblique direction with respect to the observation surface onto a base (screen substrate) having a plurality of concaves or convexes on the observation surface so as to form a reflection film on apart of each surface of the concaves or convexes.

However, in the case of a reflection type screen which is of a winding-type and has a flat rear surface of the screen base, hemispherical projections formed on the reflection surface of the reflection type screen contact the flat rear surface when the screen is wound. In this case, the contact resistance produced therebetween increases. As a result, the base of the screen is electrostatically charged with ease by repeated separation and contact between the hemispherical projections and the flat surface in accordance with the roll rotation at the time of expansion or storage of the screen base. When the reflection type screen is electrostatically charged, the reflection surface is easily contaminated by dust adhering thereto, in which condition the reflectance of the reflection surface lowers. Moreover, the high contact resistance causes crush of the hemispherical projections on the reflection surface or damage to the reflection films selectively provided on the hemispherical projections. Therefore, development of a reflection type screen capable of reducing the contact resistance produced between the reflection surface and the rear surface of the screen base, and a method of manufacturing this reflection type screen has been demanded.

### SUMMARY

An advantage of some aspects of the invention is to provide a technology capable of solving at least a part of the aforementioned problems, and the invention can be implemented as the following forms or application examples.

### Application Example 1

This application example is directed to a reflection type screen reflecting projection light including a sheet-shaped base which is flexible and has a first surface reflecting the projection light and a second surface as the surface opposite to the first surface. The second surface has an uneven shape.

According to the reflection type screen having this structure, the second surface as the surface opposite to the first surface (i.e., the rear surface of the first surface) has the uneven shape. In this case, the first surface for reflecting the projection light contacts the uneven shape of the second surface when the reflection type screen is wound and stored. However, since the second surface is not a flat surface unlike the related art which has a flat surface as the corresponding surface, the contact area between the first surface and the second surface decreases. Accordingly, the contact resistance produced therebetween lowers.

### Application Example 2

In the reflection type screen of the above application example, it is preferable that the uneven shape is uniformly formed.

According to the reflection type screen having this structure, the uneven shape is uniformly formed on the second surface. Thus, the advantage of the improved appearance of the second surface can be provided as well as the advantage of the application example 1.

### Application Example 3

In the reflection type screen of the above application example, it is preferable that the uneven shape has crimps.

According to the reflection type screen having this structure, the uneven shape of the second surface has crimps. Thus, the feel of the material of the second surface improves.

### Application Example 4

This application example is directed to a method of manufacturing a reflection type screen including forming an uneven shape on a second surface of a sheet-shaped base which is flexible and has a first surface reflecting the projection light and the second surface as the surface opposite to the first surface.

According to the method of manufacturing a reflection type screen of this application example, the uneven shape of the second surface is produced by the uneven shape forming process. In this case, the first surface for reflecting the projection light contacts the uneven shape of the second surface when the reflection type screen is wound and stored. However, since the second surface is not a flat surface unlike the related art which uses a flat surface as the corresponding surface, the contact area between the first surface and the second surface decreases. Accordingly, the reflection type screen manufactured by the manufacturing method of this application example can reduce the contact resistance produced between the first and second surfaces.

### Application Example 5

In the method of manufacturing a reflection type screen of the above application example, it is preferable that the uneven shape is transferred when the uneven shape is formed.

According to the method of manufacturing a reflection type screen of this application example, the uneven shape is transferred in the transfer process. Thus, the uneven shape can be easily formed on the second surface.

### Application Example 6

In the method of manufacturing a reflection type screen of the above application example, it is preferable that a mold having the uneven shape is heated and pressed against the base when the uneven shape is transferred. In this case, the mold is made of heat-resistant synthetic resin.

According to the method of manufacturing a reflection type screen of this application example, the transfer process is carried out by using the heat-resistant synthetic resin member for a mold. In the case of a method in the related art which uses a metal mold for forming a concave or convex shape on a base front surface of a screen base, for example, a heat-resistant synthetic resin member as an adhesion preventing member is provided between a buffering member and the base rear surface so as to prevent adhesion between the base rear surface and the buffering member caused by fusion of the base rear surface. According to the method of this application example, however, the transfer is performed by using the heat-resistant synthetic resin member having the uneven shape, for example, as a mold which also functions as the adhesion preventing member of the related art. Accordingly, the efficiency of the mold structure containing no metal mold improves, and simplification of the mold increases.

### Application Example 7

In the method of manufacturing a reflection type screen of the above application example, it is preferable that the synthetic resin member has a sheet shape or a roll shape.

According to the method of manufacturing a reflection type screen of this application example, the transfer process is carried out by using either the sheet-shaped synthetic resin member or the roll-shaped synthetic resin member. Thus, the degree of selection of the device increases.

### Application Example 8

In the method of manufacturing a reflection type screen of the above application example, it is preferable that the method further includes deforming the base such that a plurality of concaves or a plurality of convexes are formed on the first surface. In this case, the transfer of the uneven shape is performed when the base is deformed.

According to the method of manufacturing a reflection type screen of this application example, the base deforming process and the transfer process are performed at the same time. Thus, the reflection type screen can be manufactured with higher efficiency.

### BRIEF DESCRIPTION OF THE DRAWINGS

The invention will be described with reference to the accompanying drawings, wherein like numbers reference like elements.

FIG. 1 schematically illustrates a condition of installation of a reflection type screen unit according to a first embodiment.

FIGS. 2A and 2B schematically illustrate a process for manufacturing a reflection type screen.

FIGS. 3A and 3B schematically illustrate an uneven shape forming step and a base deforming step.

FIG. 4 schematically illustrates a reflection film forming step.

FIG. 5 schematically illustrates an uneven shape forming step and a base deforming step according to a second embodiment.

### DESCRIPTION OF EXEMPLARY EMBODIMENTS

Exemplary embodiments according to the invention are hereinafter described with reference to the drawings.

### First Embodiment

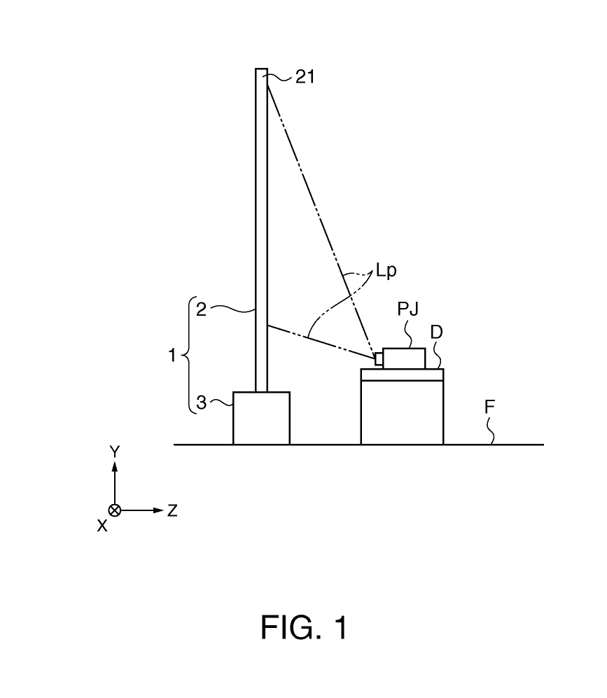

FIG. 1 schematically illustrates a condition of installation of a reflection type screen unit 1 according to a first embodiment. The general structure and operation of the reflection type screen unit 1 in this embodiment are now briefly explained with reference to FIG. 1.

The reflection type screen unit 1 in this embodiment is of a type placed on a floor surface F or other places for installation. At the time of use, a reflection type screen 2 of the reflection type screen unit 1 is drawn from the inside of a housing 3 having a rectangular parallelepiped box shape toward above (direction substantially perpendicular to the floor surface F), in which condition the reflection type screen 2 stands on the floor surface F and comes into a usable condition. The reflection type screen 2 reflects projection light Lp emitted from a projector PJ placed on a desk top surface D (or floor surface F) or others in the vicinity of the reflection type screen unit 1 such that the projection light Lp can reach an observer.

In the respective figures including FIG. 1, dimensions and proportions of the components shown therein are different from the actual ones so that these components can be visually recognized in the figures. Moreover, in the respective figures including FIG. 1, the components are shown by using an XYZ rectangular coordinate system for convenience of explanation. In this XYZ rectangular coordinate system, a Y direction corresponds to the direction perpendicular to the floor surface F (−Y direction: direction from the reflection type screen 2 in the standing condition toward the floor surface F), an X direction corresponds to the direction parallel with the surface of a screen base 21 of the standing reflection type screen 2 and perpendicular to the Y direction (+X direction: right direction as viewed from the front of the reflection surface of the reflection type screen 2 in the standing condition), and a Z direction corresponds to the direction perpendicular to the Y direction and the X direction (+Z direction: direction toward the front from the reflection surface of the reflection type screen 2 in the standing condition). Furthermore, the direction of gravity corresponds to the downward direction, and the direction opposite to the direction of gravity corresponds to the upward direction, both determined based on the direction of gravity.

As illustrated in FIG. 1, the reflection type screen unit 1 includes the reflection type screen 2 and the housing 3. The housing 3 accommodates a pantograph mechanism (not shown) in such a condition that the pantograph mechanism can freely expand and contract. The upper end of the reflection type screen 2 is fixed to the upper end of the pantograph mechanism. The lower end of the reflection type screen 2 is fixed to a spring-type winding mechanism (not shown) provided inside the housing 3, and is wound around the winding mechanism within the housing 3.

The winding mechanism is provided with a winding shaft (not shown) having a length equivalent to the length of the reflection type screen 2 in the width direction (X direction). The winding shaft has a spring member (not shown) which constantly exerts a pulling force in the winding direction. This force constantly pulls the reflection type screen 2 during use and at the time of draw and wind of the screen 2, thereby reducing looseness of the screen 2.

The pantograph mechanism in this embodiment performs expansion and contraction (upward and downward movement) in accordance with the driving of a motor (not shown). The reflection type screen 2 is drawn from the winding mechanism in accordance with the upward (+Y direction) expanding movement of the pantograph mechanism. On the other hand, the reflection type screen 2 is wound around the winding mechanism (winding shaft) and stored within the housing 3 in accordance with the downward (−Y direction) contracting movement of the pantograph mechanism.

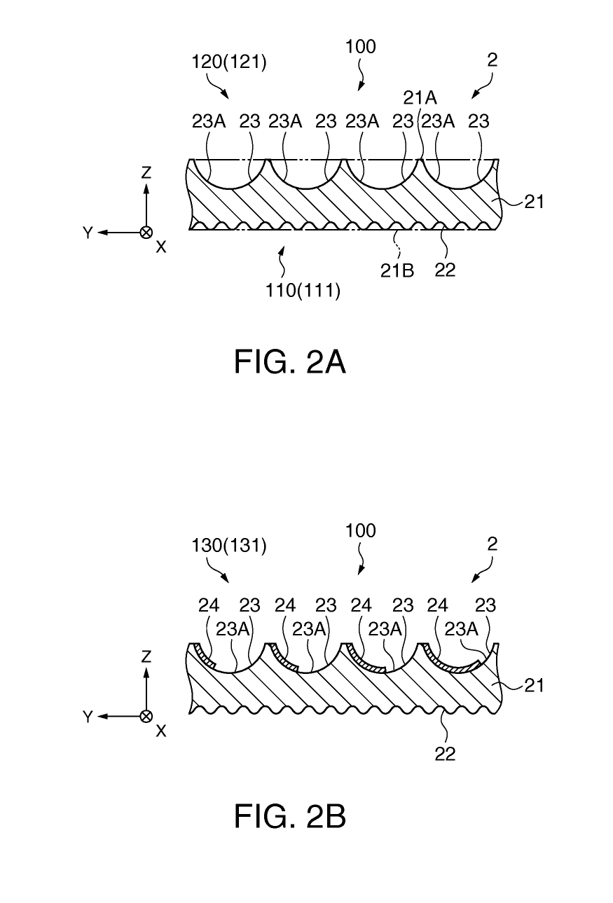

FIGS. 2A and 2B schematically illustrate a manufacturing process 100 of the reflection type screen 2. FIG. 2A schematically illustrates an uneven shape forming step 110 and a base deforming step 120. FIG. 2B schematically illustrates a reflection film forming step 130. The manufacturing process 100 of the reflection type screen 2 is now explained with reference to FIGS. 2A and 2B.

The reflection type screen 2 is formed on a flexible sheet-shaped base (hereinafter referred to as the screen base 21). In this embodiment, the screen base 21 is made of black vinyl chloride resin. The screen base 21 is black because this color absorbs unnecessary incident light.

The manufacturing process 100 shown in FIGS. 2A and 2B is performed by the method of roll-to-roll system which uses a several-hundred-meter-long screen base material wound in a roll shape. This method produces a plurality of the screen bases 21 connected with each other in a long shape in the left-right direction of the reflection type screen 2 (screen base 21) in its standing condition as the screen of the reflection type screen unit 1. FIGS. 2A and 2B are enlarged cross-sectional views showing the main part produced after the respective steps.

The manufacturing process 100 includes the uneven shape forming step 110, the base deforming step 120, and the reflection film forming step 130. According to this embodiment, the uneven shape forming step 110 and the base deforming step 120 of the manufacturing process 100 are performed substantially at the same time in the same process by using an embossing device 200 (described later). After the end of the steps 110 and 120, the process proceeds to the reflection film forming step 130. Each of the steps 110 through 130 uses a not-shown feeding device which sequentially draws each length of the screen base 21 from the screen base material wound in a roll shape, and sequentially winds the screen base 21 after processing.

As illustrated in FIG. 2A, the uneven shape forming step 110 is a step for forming an uneven surface (uneven surface 22) on a base rear surface 21B as a second surface of the screen base 21. The uneven shape forming step 110 in this embodiment includes a transfer step (hereinafter referred to as an uneven surface transfer step 111). The uneven surface transfer step 111 is performed by using the embossing device 200 functioning as a transfer device which presses heated molds. The uneven surface 22 is uniformly formed on the substantially entire area of the base rear surface 21B. In this embodiment, the uneven surface 22 is constituted by a so-called crimped surface. The crimped surface in this embodiment has crepe weave patterns. However, the crimped surface may have mesh patterns or others as well as crepe weave patterns.

The base deforming step 120 deforms a base front surface 21A as a first surface of the screen base 21. The base deforming step 120 in this embodiment includes a transfer step. According to this embodiment, the transfer step (hereinafter referred to as a concave surface transfer step 121) deforms the base front surface 21A into a shape having a plurality of concaves 23. The concave surface transfer step 121 is performed by using the embossing device 200 similarly to the uneven surface transfer step 111.

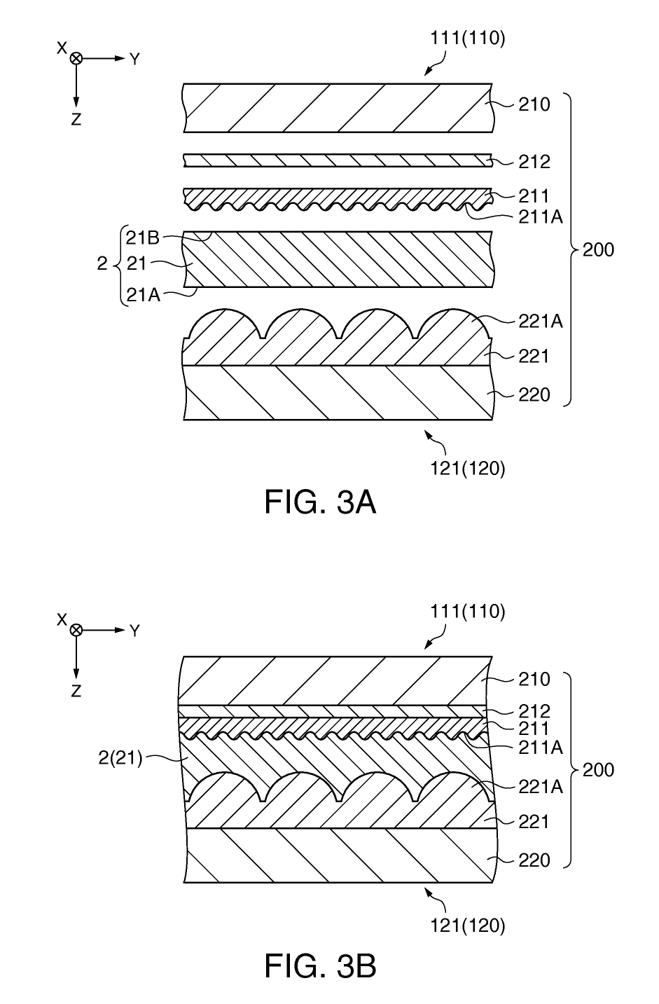

FIGS. 3A and 3B schematically illustrate the uneven shape forming step 110 and the base deforming step 120. FIG. 3A is a cross-sectional view illustrating the general structure of the embossing device 200. FIG. 3B is a cross-sectional view schematically illustrating a condition of operation of the embossing device 200. The transfer steps (uneven surface transfer step 111 and concave surface transfer step 121) included in the uneven shape forming step 110 and the base deforming step 120 are now explained in conjunction with the structure and operation of the embossing device 200 with reference to FIGS. 3A and 3B.

The embossing device 200 is provided with planar molds. The embossing device 200 is a device which presses molds shaped into the reverse of the shape to be formed against the screen base 21 from above and below with high pressure while heating the molds so as to form the necessary shape through thermal deformation (transfer) of the screen base 21 in correspondence with the mold shape.

As illustrated in FIG. 3A, the embossing device 200 has a lower metal mold base 220 positioned below the screen base 21, and a metal mold 221 positioned on the lower metal mold base 220 and having convexes 221A. The embossing device 200 also has an upper metal mold base 210 positioned above the screen base 21. The upper metal mold base 210 has a flat surface on the side facing to the screen base 21.

The embossing device 200 further has an uneven mold 211 disposed between the upper metal mold base 210 and the screen base 21 and provided with an uneven portion 211A having an uneven shape. According to this embodiment, the uneven mold 211 is made of synthetic resin. The synthetic resin forming the uneven mold 211 in this embodiment is sheet-shaped heat-resistant Teflon (trademark) resin.

The embossing device 200 further has a buffering member 212 disposed between the upper metal mold base 210 and the uneven mold 211 so that pressure can be uniformly applied to the screen base 21 via the buffering member 212 during transfer. In this embodiment, the buffering member 212 is made of felt.

The uneven mold 211 in this embodiment also has a function as an adhesion preventing member which prevents adhesion between the buffering member 212 and the base rear surface 21B by fusion of the base rear surface 21B during operation of the embossing device 200.

For performing the uneven shape forming step 110 and the base deforming step 120, the screen base 21 in a roll shape is initially drawn out and placed on the embossing device 200. More specifically, as illustrated in FIG. 3A, the screen base 21 is disposed in such a position that the base front surface 21A of the screen base 21 faces to the metal mold 221, and that the base rear surface 21B faces to the uneven mold 211. After the setting, the operation of the embossing device 200 is started. At this time, the lower metal mold base 220 and the upper metal mold base 210 are heated. During operation of the embossing device 200, the lower metal mold base 220 is fixed so that the screen base 21 can be pressed by the lower metal mold base 220 in accordance with the downward movement of the upper metal mold base 210.

As illustrated in FIG. 3B, the uneven surface transfer step 111 and the concave surface transfer step 121 are performed substantially at the same time by the press of the lower metal mold base 220 and the upper metal mold base 210 of the embossing device 200 against the screen base 21. By this method, the shape of the uneven portion 211A of the uneven mold 211 is transferred to the base rear surface 21B by thermal deformation. As a result, the uneven surface 22 shown in FIG. 2A is produced. On the other hand, the convexes 221A of the metal mold 221 are transferred to the base front surface 21A by thermal deformation. As a result, the concaves 23 shown in FIG. 2A are produced.

The concaves 23 are formed on the substantially entire area of the base front surface 21A. For example, the concaves 23 are disposed in a circular-arc shape around the center of a predetermined position on the center line (not shown) of the reflection type screen 2 in the X direction, and in a concentric shape around this center in the Y direction. According to this embodiment, each of the concaves 23 has a substantially hemispherical shape. The concaves 23 may be disposed at other positions in correspondence with the positional relationship between the reflection type screen 2 and the projector PJ during use or other conditions.

The uneven shape forming step 110 and the base deforming step 120 successively form the uneven surface 22 and the concaves 23 on the screen base 21 drawn by each length of the screen base 21 by the method of roll-to-roll system.

Returning to FIGS. 2A and 2B, the process shifts to the subsequent reflection film forming step 130 after the end of the uneven shape forming step 110 and the base deforming step 120. As illustrated in FIG. 2B, the reflection film forming step 130 is a step for selectively forming reflection films 24 on inner surfaces 23A of the concaves 23. According to this embodiment, the reflection film forming step 130 includes a depositing step 131. The depositing step 131 in this embodiment selectively forms aluminum films on the inner surfaces 23A.

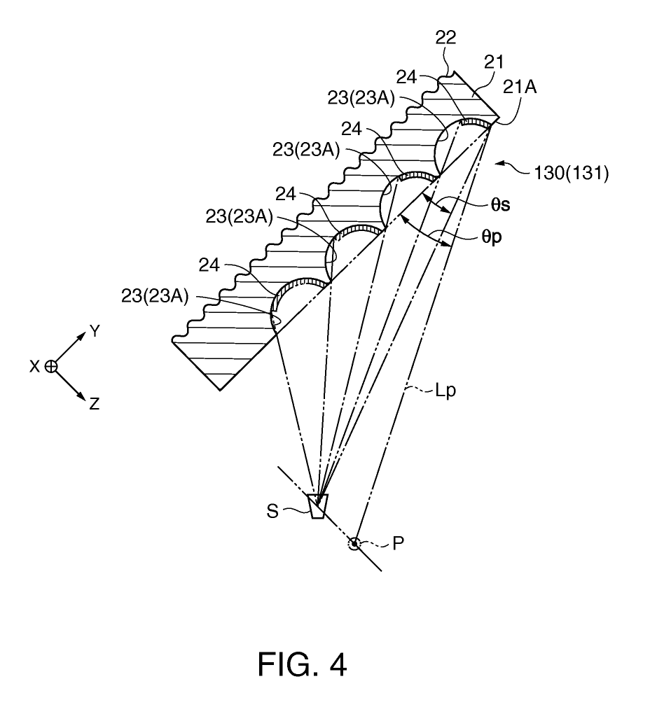

FIG. 4 schematically illustrates the reflection film forming step 130. The depositing step 131 of the reflection film forming step 130 is now explained with reference to FIG. 4.

The depositing step 131 draws the screen base 21 wound in a roll shape in such a direction that the base front surface 21A is opposed and inclined to the upper side of a depositing source S, and attaches the leading end of the screen base 21 to a roll member of the winding part. In this case, the base front surface 21A is attached in such a position that the upper side of the screen base 21 is located farther away from the depositing source S than the lower side of the screen base 21. The depositing source S is disposed on the center line (not shown) of the reflection type screen 2 in the X direction, and positioned in the vicinity of the lower side of the screen base 21. The upper side of the screen base 21 corresponds to the upper side of the screen base 21 of the reflection type screen 2 in the standing condition.

More specifically, for producing the reflection films 24, the depositing step 131 assumes beforehand that the position of the projector PJ emitting the projection light Lp in an oblique direction with respect to the base front surface 21A corresponds to a virtual light source position P. Then, the depositing step 131 locates the depositing source S in such a position that a depositing angle θs formed by the depositing material and each of the concaves 23 on the base front surface 21A becomes equivalent to or smaller than an incident angle θp formed by the projection light Lp coming from the virtual light source position P and each of the concaves 23 on the base front surface 21A, and deposits the depositing material on each of the concaves 23 in the incident direction of the projection light Lp.

After the end of the depositing step 131, the concave-shaped reflection film 24 is produced on each part of the inner surfaces 23A of the concaves 23 to which the projection light Lp is applied. The reflection films 24 selectively deposited in the oblique direction onto partial areas of the respective concaves 23 of the base front surface 21A are radially disposed around the depositing source S. Each thickness of the reflection film 24 gradually decreases as the distance between the reflection film 24 and the depositing source S becomes longer. The reflection films 24 formed by deposition become thinner and higher-quality than when formed by spray-coating, printing, or other methods.

Similarly to the above steps, the reflection film forming step 130 successively forms the reflection films 24 on the screen base 21 drawn by each length of the screen base 21 by the method of roll-to-roll system. The screen bases 21 (reflection type screens 2) manufactured by the manufacturing process 100 are cut from each other to have the predetermined length in the subsequent step, each of which cut pieces becomes the reflection type screen 2 to be assembled into the reflection type screen unit 1.

The reflection type screen 2 manufactured by the manufacturing process 100 and incorporated in the reflection type screen unit 1 efficiently reflects the projection light Lp emitted from the projector PJ in such a direction that the projection light Lp can reach the observer by the function of the reflection films 24 formed on the reflection type screen 2. Moreover, unnecessary external light coming from a fluorescent light or the like toward the reflection type screen 2, if any, is absorbed by the parts of the concaves 23 other than the reflection films 24, and thus cannot be easily reflected toward the observer. Furthermore, the uneven surface 22 provided on the base rear surface 21B irregularly reflects external light entering from the rear surface side of the reflection type screen 2 to increase the degree of light shielding. Therefore, contrast of the reflection type screen 2 increases.

In addition, the reflection type screen 2 manufactured by the manufacturing process 100 and assembled into the reflection type screen unit 1 is wound around the winding mechanism (winding shaft) in such a condition that the concaves 23 (and the reflection films 24) formed on the base front surface 21A of the screen base 21 overlap with the uneven surface 22 formed on the base rear surface 21B when stored within the housing 3. On the other hand, the reflection type screen 2 is expanded in such a condition that the concaves 23 on the base front surface 21A are separated from the uneven surface 22 on the base rear surface 21B when drawn from the winding mechanism.

According to the first embodiment, the following advantages can be provided.

The reflection type screen 2 in this embodiment has the uneven surface 22 on the base rear surface 21B. Thus, the contact area between the uneven surface 22 of the base rear surface 21B and the concaves 23 of the base front surface 21A becomes smaller than the contact area between the concaves 23 and a flat base rear surface provided as the corresponding surface in the related art even when the reflection type screen 2 is stored with the concaves 23 and the uneven surface 22 overlapping with each other. In this case, the contact resistance produced between the concaves 23 and the uneven surface 22 becomes smaller than the contact resistance between the concaves 23 and the flat base rear surface in the related art at the time of expansion with separation between the concaves 23 and the uneven surface 22. Accordingly, the screen base 21 is not electrostatically charged with ease due to decrease in the contact resistance, which prevents generation of static electricity.

Moreover, the structure capable of preventing generation of static electricity in this embodiment can eliminate the possibility of adhesion of dust to the concaves 23 including the reflection films 24 and contamination in this area caused thereby. Therefore, the reflectance of the reflection films 24 does not lower.

According to the reflection type screen 2 in this embodiment, the uneven surface 22 is formed on the base rear surface 21B. In this case, the contact resistance between the uneven surface 22 and the concaves 23 on the base front surface 21A decreases, which prevents crush of the concaves 23 and damage to the reflection films 24.

According to the reflection type screen 2 in this embodiment, the uneven surface 22 is uniformly formed, and shaped to have crimps (crepe weave patterns). In this case, the feel of the material of the base rear surface 21B as the second surface improves, and enhances the external appearance of the reflection type screen 2.

The method of manufacturing the reflection type screen 2 in this embodiment includes the uneven shape forming step 110 which forms the uneven surface 22 on the base rear surface 21B as the second surface. According to this structure, the base front surface 21A provided as the surface for reflecting the projection light can be brought into contact with the uneven surface 22 formed on the base rear surface 21B when the reflection type screen 2 is wound and stored. In this case, the contact area between the base front surface 21A and the base rear surface 21B as a non-flat surface decreases when compared with the contact area between the base front surface and a flat base rear surface provided as the corresponding surface in the related art. Accordingly, the reflection type screen 2 capable of reducing the contact resistance can be manufactured.

According to the method of manufacturing the reflection type screen 2 in this embodiment, the uneven shape forming step 110 includes the transfer step (uneven surface transfer step 111) which transfers the uneven shape (uneven portion 211A). Thus, the uneven surface 22 can be easily and efficiently formed on the base rear surface 21B by the transfer of the uneven portion 211A performed in the uneven surface transfer step 111.

According to the method of manufacturing the reflection type screen 2 in this embodiment, the uneven surface transfer step 111 carries out the transfer step by using the mold made of heat-resistant sheet-shaped Teflon resin for a mold. According to a method of the related art which uses a metal mold for forming a concave shape on a base front surface of a screen base, for example, a heat-resistant synthetic resin member as an adhesion preventing member is provided between a buffering member and the base rear surface so as to prevent adhesion between the base rear surface and the buffering member caused by fusion of the base rear surface. According to the method in this embodiment, however, the uneven surface transfer step 111 is performed by using the heat-resistant Teflon resin as the uneven mold 211 which functions both as the adhesion preventing member of the related art and as a mold. Accordingly, the efficiency of the mold structure improves, and simplification of the mold increases.

According to the method of manufacturing the reflection type screen 2 in this embodiment, the uneven surface transfer step 111 of the uneven shape forming step 110 and the concave surface transfer step 121 of the base deforming step 120 are performed substantially at the same time in the same process. Thus, the efficiency of the method for manufacturing the reflection type screen 2 increases.

### Second Embodiment

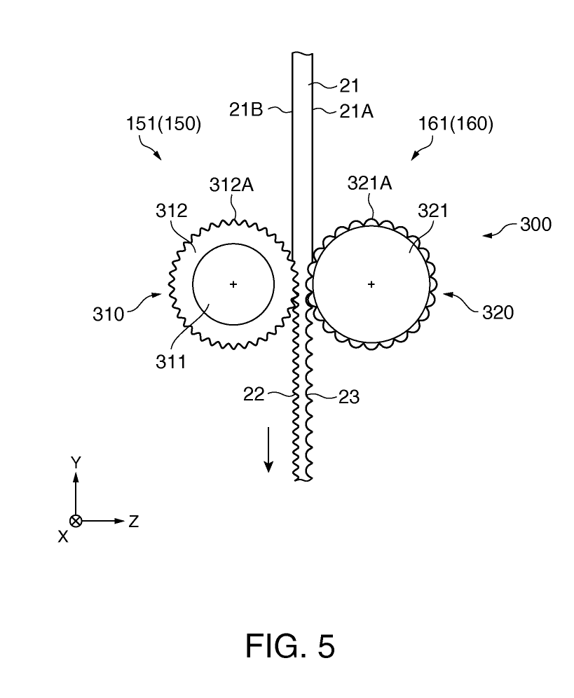

FIG. 5 schematically illustrates an uneven shape forming step 150 and a base deforming step 160 according to the second embodiment. Transfer steps (uneven surface transfer step 151 and concave surface transfer step 161) included in the uneven shape forming step 150 and the base deforming step 160 in this embodiment are now explained with reference to FIG. 5.

The reflection type screen 2 in this embodiment is manufactured by a method different from the method for manufacturing the reflection type screen 2 in the first embodiment. More specifically, while the transfer steps in the first embodiment (uneven surface transfer step 111 and concave surface transfer step 121) are performed by using the embossing device 200 having the planar molds, the transfer steps (uneven surface transfer step 151 and concave surface transfer step 161) in this embodiment are executed by using an embossing device 300 having roll-shaped molds. Other points are the same as the corresponding points in the first embodiment. In the description of this embodiment, the parts and components same as the parts and components in the first embodiment have been given the same reference numbers.

The uneven shape forming step 150 (uneven surface transfer step 151) and the base deforming step 160 (concave surface transfer step 161) in this embodiment correspond to the uneven shape forming step 110 (uneven surface transfer step 111) and the base deforming step 120 (concave surface transfer step 121) in the first embodiment. The uneven shape forming step 150 and the base deforming step 160 are performed by using the embossing device 300 substantially at the same time similarly to the first embodiment. Moreover, the uneven shape forming step 150 and the base deforming step 160 are carried out while sequentially drawing the screen base 21 wound in a roll shape by each length of the screen base 21 and winding the processed screen base 21 similarly to the first embodiment.

As illustrated in FIG. 5, the embossing device 300 has a cylindrical receiving roller 310 and a cylindrical embossing roller 320. The receiving roller 310 and the embossing roller 320 are disposed to be opposed to each other, and rotatably supported around the center axis.

The receiving roller 310 has a receiving roller main body 311, and an uneven mold 312 provided on the outer circumferential surface of the receiving roller main body 311. The uneven mold 312 has an uneven portion 312A. The uneven mold 312 is constituted by a heat-resistant roll-shaped Teflon resin or silicon rubber similarly to the first embodiment. Crimps (crepe weave patterns in this embodiment) are uniformly provided on the surface of the uneven mold 312 as the uneven portion 312A. The embossing roller 320 is constituted by a metal mold which has convexes 321A on the outer circumferential surface of an embossing roller main body 321.

For performing the uneven shape forming step 150 and the base deforming step 160 by using the embossing device 300 having this structure, the heated screen base 21 is initially inserted between the embossing roller 320 and the receiving roller 310 in the direction from above to below. More specifically, the screen substrate 21 is sandwiched in the condition of contact between the base front surface 21A and the embossing roller 320 and between the base rear surface 21B and the receiving roller 310.

In this condition, the convexes 321A are pressed against the base front surface 21A to transfer the shape of the convexes 321A thereto in accordance with the rotation of the embossing roller 320. As a result, the concaves 23 are formed on the base front surface 21A. On the other hand, the uneven portion 312A is pressed against the base rear surface 21B to transfer the shape of the uneven portion 312A thereto in accordance with the rotation of the receiving roller 310. As a result, the uneven surface 22 is formed on the base rear surface 21B.

After the end of the uneven shape forming step 150 and the base deforming step 160 performed by using the embossing device 300, the process proceeds to the reflection film forming step 130 similarly to the first embodiment.

According to the second embodiment, the following advantage can be offered as well as the advantages provided by the first embodiment.

According to the reflection type screen 2 in this embodiment, the transfer steps (uneven surface transfer step 151 and the concave surface transfer step 161) use the embossing device 300 having the roll-shaped molds unlike the first embodiment which uses the embossing device 200 having the planar molds in the transfer steps (uneven surface transfer step 111 and the concave surface transfer step 121). Thus, the device used for performing the transfer steps can be arbitrarily selected from the embossing devices 200 and 300, which increases the degree of freedom for selection of these devices.

It should be understood that the invention is not limited to the embodiments described herein but may be practiced otherwise without departing from the scope of the invention. Therefore, various modifications and improvements including the following modified examples may be made.

According to the reflection type screen 2 in the first embodiment, the plural concaves 23 are formed on the base front surface 21A of the screen base 21. However, a plurality of convexes may be provided thereon instead of the concaves 23. These convexes can be formed by replacing the metal mold 221 of the embossing device 200 with a metal mold having concaves. In this case, reflection films are selectively formed on the plural convexes thus transferred similarly to the first embodiment. Furthermore, in the case of the embossing device 300 in the second embodiment, a plurality of convexes can be formed on the base front surface 21A by replacing the embossing roller 320 having the convexes 321A with an embossing roller having concaves.

According to the reflection type screen 2 in the first embodiment, the uneven mold 211 is made of heat-resistant sheet-shaped Teflon resin. However, the uneven mold 211 may be made of heat-resistant sheet-shaped silicon resin. Similarly, heat-resistant roll-shaped silicon resin may be used in the second embodiment. The material may be any types as long as they are heat-resistant synthetic resin.

According to the reflection type screen 2 in the first and second embodiments, the uneven surface 22 provided on the base rear surface 21B is uniformly formed on the substantially entire area of the base rear surface 21B as a surface having crimps. These crimps have crepe weave patterns. However, various types of patterns as well as crepe weave patterns may be formed as long as the uneven shape of the uneven surface 22 does not have effect on the base front surface 21A of the screen base 21. For example, leather patterns, wood-grain patterns, or patterns created based on image data may be selected. Alternatively, logotypes of a corporation or a product, for example, may be used as patterns. These patterns can give the user a positive impression of the image of the corporation or the product.

According to the reflection type screen 2 in the first and second embodiments, the uneven shape forming step 110 (150) and the base deforming step 120 (160) are performed at the same time by using the embossing device 200 (300). However, these steps may be carried out separately.

According to the reflection type screen 2 in the first and second embodiments, the feeding device is provided for each step of the manufacturing process 100. In this structure, the screen base wound in a roll shape is sequentially drawn by each length of the screen base 21, and sequentially wound after the processing. However, the respective steps may be performed by using cut pieces of the screen base 21 separated beforehand by each length of the screen base 21.

According to the reflection type screen 2 in the first and second embodiments, the plural concaves 23 are formed on the base front surface 21A (the side to which the projection light Lp is applied), and the reflection films 24 are selectively provided on the plural concaves 23. However, the surface of the reflection type screen 2 to which the projection light Lp is applied may have other structures as long as they can reflect incident light. For example, the screen base may have a surface painted with white paint, a surface having concaves and convexes of lenticular lenses, a surface to which aluminum foil is affixed to provide mat film or other coating thereon, or a surface to which fine glass powder (beads) is applied.

According to the reflection type screen unit 1 in the first and second embodiments, the reflection type screen 2 expands and contracts by electrical driving. However, the reflection type screen 2 of the reflection type screen unit 1 may be manually wound around a cylindrical member.

According to the reflection type screen 2 in the first and second embodiments, the concaves 23 are arranged in a circular-arc shape around the predetermined position on the centerline. However, the concaves 23 may be linearly disposed in the Y direction or the X direction.

According to the reflection type screen 2 in the first and second embodiments, the pitch, depth, and other conditions of the concaves 23 may be determined based on the easiness of manufacture and the reflection efficiency, for example.

According to the reflection type screen unit 1 in the first and second embodiments, the reflection type screen 2 is wound around the winding mechanism (winding shaft) when stored. However, the reflection type screen 2 may be folded in the shape of bellows for storage.

In the first and second embodiments, the reflection type screen unit 1 of a type placed on the floor surface F has been discussed. However, the reflection type screen unit 1 may be fixed to a wall surface, or fixed to a desk, a stand, or other places.

According to the reflection type screen unit 1 placed on the floor surface F in the first and second embodiments, the reflection type screen 2 is drawn from the inside of the housing 3 toward above (substantially in the vertical direction with respect to the floor surface F). However, the reflection type screen of the reflection type screen unit fixed to a ceiling or a wall surface close to a ceiling may be drawn from the inside of the housing toward the floor surface in the downward direction.

The entire disclosure of Japanese Patent Application No. 2010-278925, filed Dec. 15, 2010 is expressly incorporated by reference herein.

What is claimed is:

1. A reflection type screen reflecting projection light, comprising:
a sheet-shaped base which is flexible and has a first surface reflecting the projection light and a second surface as the surface opposite to the first surface,
wherein the second surface has an uneven shape.

2. The reflection type screen according to claim 1, wherein the uneven shape is uniformly formed.

3. The reflection type screen according to claim 1, wherein the uneven shape has crimps.

4. A method of manufacturing a reflection type screen reflecting projection light, comprising:
forming an uneven shape on a second surface of a sheet-shaped base which is flexible and has a first surface reflecting the projection light and the second surface as the surface opposite to the first surface.

5. The method of manufacturing a reflection type screen according to claim 4, wherein the uneven shape is transferred when the uneven shape is formed.

6. The method of manufacturing a reflection type screen according to claim 5, wherein
a mold having the uneven shape is heated and pressed against the base when the uneven shape is transferred; and
the mold is formed by a heat-resistant synthetic resin member.

7. The method of manufacturing a reflection type screen according to claim 6, wherein the synthetic resin member has a sheet shape or a roll shape.

8. The method of manufacturing a reflection type screen according to claim 5, further comprising:
deforming the base such that a plurality of concaves or a plurality of convexes are formed on the first surface,
wherein the transfer of the uneven shape is performed when the base is deformed.
